(19) United States
(12) Patent Application Publication
(10) Pub. No.: US 2019/0324288 A1
(43) Pub. Date: Oct. 24, 2019

(54) ARTICULATED TEMPLE FOR EYEWEAR

(71) Applicant: NORTH INC., Kitchener (CA)

(72) Inventors: Joshua Moore, Elora (CA); Stephen E. Orzel, Hamilton (CA)

(21) Appl. No.: 16/382,638

(22) Filed: Apr. 12, 2019

Related U.S. Application Data
(60) Provisional application No. 62/660,668, filed on Apr. 20, 2018.

(51) Int. Cl. G02C 5/20

(52) U.S. Cl. CPC G02C 5/20; G02C 5/2209

(57) ABSTRACT

An articulated temple includes a temple arm, a temple end piece, and a hinge having a first hinge leaf coupled to the temple arm and a second hinge leaf coupled to the temple end piece. A pivot joint having a pivot axis is formed between the first and second hinge leaves. Each of the temple arm and temple end piece has a top curved edge. The top curved edges are concentric about the pivot axis provided by the hinge to enable one of the curved edges to move relative to the other curved edge along a portion of a circular path when the temple end piece is pivoted relative to the temple arm about the pivot axis. An eyewear including the articulated temple is disclosed.

### CROSS-REFERENCE TO RELATED APPLICATIONS

This application claims the benefit of U.S. Provisional Application No. 62/660,668, filed Apr. 20, 2018, titled “Articulated Temple for Eyewear,” the content of which is incorporated herein in its entirety by reference

### TECHNICAL FIELD

The disclosure generally relates to structures that enable folding of eyewear into a compact form and more particularly to structures that enable folding of an eyewear temple.

### BACKGROUND

There has been significant interest lately in wearable heads-up displays, or near-eye displays, that look like conventional eyeglasses. Wearable heads-up displays enable users to see displayed content without preventing the users from seeing the environment. Conventional eyeglasses have hinges where the temples meet the frame front, which enable folding of the temples inward for compact storage of the eyeglasses. In contrast, wearable heads-up displays may have display-generating components present at the connections between the frame front and the temples that prevent placement of hinges between the frame front and temples. There is a need for structures to enable folding of wearable heads-up display into a compact form in cases where the design of the wearable heads-up display does not allow for hinges to be placed at the connections between the frame front and temples.

### SUMMARY

An articulated temple may be summarized as including: a temple arm having a rear end and a top surface, the top surface of the temple arm terminating in a first curved edge at the rear end; a temple end piece having a front end to be positioned in opposing relation to the rear end of the temple arm such that the temple arm and the temple end piece together form a temple having a select shape and length, the temple end piece having a top surface, the top surface of the temple end piece terminating in a second curved edge at the front end; and a hinge having a first hinge leaf coupled to the temple arm and a second hinge leaf coupled to the temple end piece, the hinge having a pivot joint formed between the first hinge leaf and the second hinge leaf, the pivot joint proximate the rear end of the temple arm and the front end of the temple end piece, the pivot joint defining a pivot axis; where the first curved edge and the second curved edge are concentric about the pivot axis to enable the second curved edge to move relative to the first curved edge along a portion of a circular path when the temple end piece is pivoted relative to the temple arm about the pivot axis.

Each of the first curved edge and the second curved edge may have a constant radius arc profile.

The first curved edge and the second curved edge may be spaced part by a gap. The width of the gap between the first curved edge and the second curved edge may be in a range from 0.1 mm to 0.5 mm.

The articulated temple may have a folded configuration where the temple end piece is pivoted relative to the temple arm in a first direction by a first angle. The articulated temple may have an over-flexed configuration where the temple end piece is pivoted relative to the temple arm in a second direction while the temple end piece is subjected to an applied lateral force. A maximum value of the first angle may be in a range from 80° to 100°, and a maximum value of the second angle may be in a range from 5° to 20°.

The articulated temple may include a spring that loads the pivot joint.

The first hinge leaf may include a frame and a spring housing slidably engaging the frame. The spring may be arranged between the spring housing and the frame to respond to relative sliding between the spring housing and the frame.

The second hinge leaf may contact the spring housing to transfer pivoting motion of the second hinge leaf relative to the first hinge leaf to sliding motion of the spring housing relative to the frame.

The pivot joint may be located in an interior of one of the temple arm and temple end piece.

The first hinge leaf may be disposed in a pocket in the interior of the temple arm and coupled to a wall of the pocket by at least one fastener. The wall may be positioned and oriented to hide the fastener within the temple arm.

The second hinge leaf may include a hinge plate having a knuckle formed at an end thereof. The pivot joint may be formed between the knuckle and the first hinge leaf.

The temple end piece may be a molded body. A portion of the hinge plate may include a serrated surface. The portion of the hinge plate including the serrated surface may be embedded in the temple end piece to lock the hinge plate to the temple end piece.

The temple end piece may be a molded body. The second hinge leaf may include a wire that is attached to the hinge plate. The wire may be embedded in the temple end piece to retain a shape of the temple end piece.

The first hinge leaf may include at least a first stop surface that limits pivoting of the second hinge relative to the first hinge leaf in a first direction and at least a second stop surface that limits pivoting of the second hinge relative to the first hinge leaf in a second direction.

The at least a first stop surface may be a tapered surface, and the second hinge may include at least one tapered surface that is in a parallel arrangement with the at least a first stop surface and separated from the at least a first stop surface by a gap when the second hinge leaf is axially aligned with the first hinge leaf.

An eyewear may be summarized as including a frame front carrying at least one lens and at least one articulated temple as summarized above coupled to a side of the frame.

The at least one articulated temple may carry at least one display component.

The foregoing general description and the following detailed description are exemplary of various embodiments of the invention(s) and are intended to provide an overview or framework for understanding the nature of the invention(s) as it is claimed. The accompanying drawings are included to provide further understanding of various embodiments of the invention(s) and are incorporated in and constitute part of this specification. The drawings illustrate various embodiments of the invention(s) and together with the description serve to explain the principles and operation of the invention(s).

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Unless indicated otherwise, the particular shapes of the elements as drawn are not necessarily intended to convey any information regarding the actual shape of the particular elements and have been solely selected for ease of recognition in the drawing.

FIG. 1 is a top isometric view of an eyewear incorporating articulated temples.

FIG. 2A is a top isometric view of an articulated temple.

FIG. 2B is a cross-section of FIG. 2A along line 2B-2B.

FIG. 2C is a top view of an articulated temple in a folded configuration.

FIG. 2D is a top view of an articulated temple in an extended configuration.

FIG. 2E is a top view of an articulated temple in an over-flexed configuration.

FIG. 3A is an enlarged detail breakout of a hinge area 3A of FIG. 2A.

FIG. 3B shows the hinge area of FIG. 3A with the temple end piece pivoted inwardly relative to the temple arm.

FIG. 3C shows the hinge area of FIG. 3A with the temple end piece pivoted outwardly relative to the temple arm.

FIG. 3D shows an alternate implementation of the hinge area of FIG. 3A.

FIG. 4A shows a top view of a hinge.

FIG. 4B shows a cross-section of FIG. 4A along line 4B-4B.

FIG. 4C is a cross-section of FIG. 4A along line 4C-4C.

FIG. 4D shows a hinge in a molded temple end piece.

FIG. 4E shows an underside of a hinge leaf of FIG. 4A.

FIG. 4F is a side view of the hinge of FIG. 4A.

FIG. 4G is an opposite side view of the hinge of FIG. 4F.

FIGS. 4H and 4I show the hinge of FIG. 4A in two different pivoted positions.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices have not been shown or described in detail to avoid unnecessarily obscuring descriptions of the embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

In this disclosure, unless the context requires otherwise, the word “comprise” and variations thereof, such as, “comprises” and “comprising” are to be construed in an open, inclusive sense, that is as “including, but not limited to.”

In this disclosure, reference to “one embodiment” or “an embodiment” means that a particular feature, structures, or characteristics may be combined in any suitable manner in one or more embodiments.

In this disclosure, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the disclosure provided herein are for convenience only and do not interpret the scope or meaning of the embodiments.

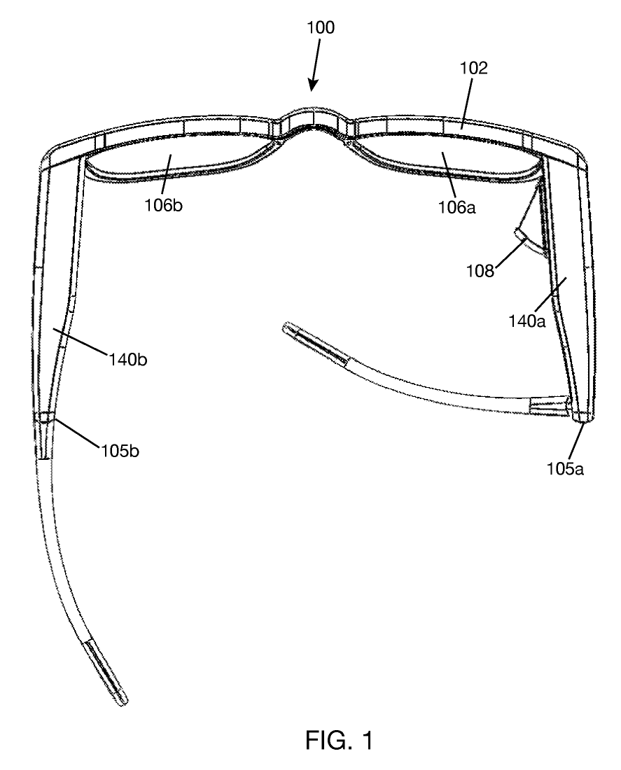

FIG. 1 shows an eyewear 100 including a frame front 102 and a pair of articulated temples 140a, 140b coupled to opposite sides of the frame front 102. Each of articulated temples 140a, 140b extends over a respective ear of a user when eyewear 100 is worn on the head of the user. In use, temples 140a, 140b keep eyewear 100 on the head of the user and frame front 102 in front of the eyes of the user. Each of articulated temples 140a, 140b has a flexible joint, located generally at 105a, 105b, respectively, that allows the respective temple to be foldable, for example, for storage of the eyewear. For illustration purposes, FIG. 1 shows temple 140a in a folded configuration and temple 140b in an extended configuration. Both of the temples 140a, 140b may be folded, e.g., for storage, or extended, e.g., for use. In some cases, flexible joints 105a, 105b may allow temples 140a, 140b to be over-flexed, for example, to make it easier to place the eyewear on the head or to allow the eyewear to be worn on different head shapes.

Frame front 102 supports lenses 106a, 106b, each of which may, or may not, carry an eye prescription. In one example, eyewear 100 is a wearable heads-up display, or near-eye display, which means that one or both of temples 140a, 140b may carry one or more components, e.g., at 108, that enable eyewear 100 to operate as a display. Such components may include, but are not limited to, laser diodes, optical scanner, optical elements such as beam shaper, beam splitter, and the like, and electronics, such as processor, memory, and battery. Frame front 102 may carry structures to enable communication between components carried by the temples 140a, 140b. Also, at least one of lenses 106a, 106b may include a light redirecting element or combiner (not shown separately), such as a holographic optical element or waveguide. In use, the light redirecting element may receive light from a light source carried in one of the temples 140a, 140b and redirect the light to the eye of the user of eyewear 100.

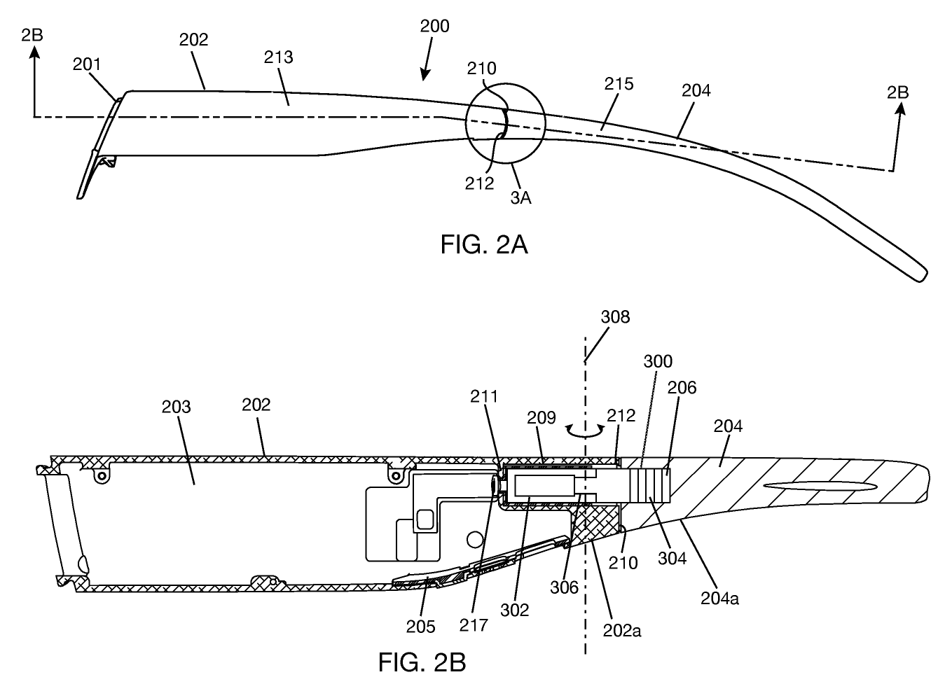

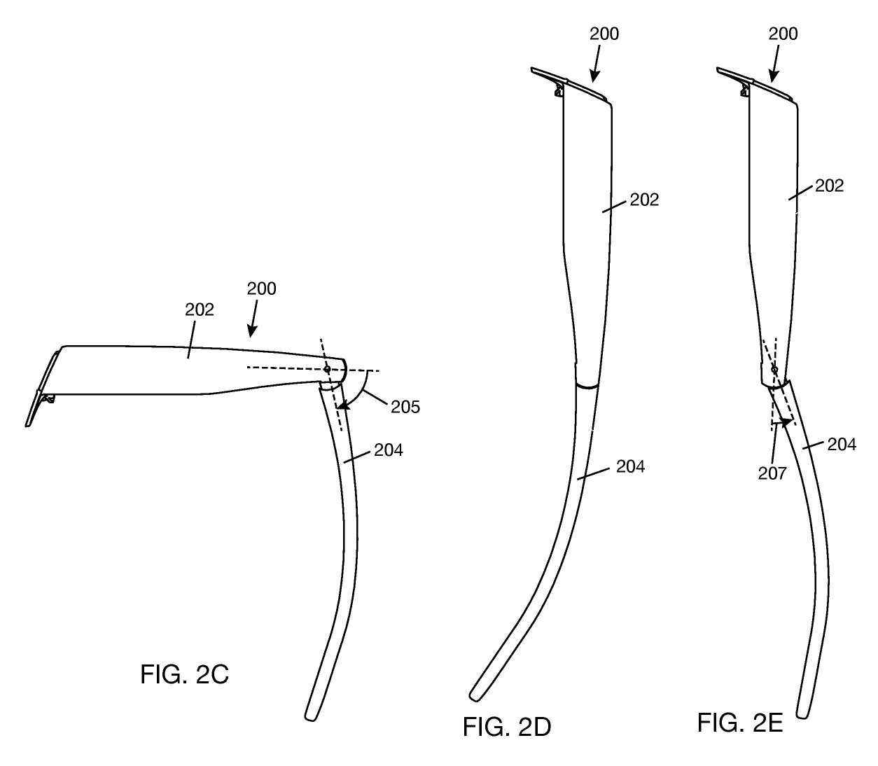

FIG. 2A shows a top view of one example articulated temple 200. Articulated temple 200 is intended to be coupled to a right side of an eyewear frame front and may be used as the articulated temple 104a in FIG. 1. A mirror image of articulated temple 200 may be coupled to a left side of the eyewear frame front and may be used as the articulated temple 104b in FIG. 1. In the interest of conciseness, a mirror image of articulated temple 200 will not be described. However, it should be clear that the mirror image of articulated temple 200 will have the same articulated structure as articulated temple 200 but may not necessarily contain the same display components, if any, as the articulated temple 200. In one implementation where temple 200 carries display components, articulated temple 200 may be attached to a right side of a frame front without a hinge in the connection between the articulated temple and the frame front. In this case, the articulated structure of the articulated temple 200 will allow the eyewear to be foldable into a compact form.

Articulated temple 200 includes a temple arm 202 and a temple end piece 204. Both temple arm 202 and temple end piece 204 are elongated bodies. In an extended configuration of temple 200, a rear end 210 of temple arm 202 is in direct opposing relation to a front end 212 of temple end piece 204 such that temple arm 202 and temple end piece 204 together form a temple having a select shape and length. Temple arm 202 is coupled to temple end piece 204 by a hinge 300 (in FIG. 2B) that is situated proximate rear end 210 of temple arm 202 and front end 212 of temple end piece 202. This places hinge 300 (in FIG. 2B) closer to the middle of the articulated temple 200 than to the front of the articulated temple 200. A front end 201 of temple arm 202 may be connected to a frame front, with or without a separate hinge in the connection between temple 202 and the frame front. In one implementation, such as illustrated in FIG. 2B, temple arm 202 may have a cavity 203 and structures, e.g., chassis 205, within cavity 203 to hold display components. (Display components are not shown in FIG. 2B. However, a display component 108 is shown on temple arm 104a in FIG. 1, and examples of display components have been previously given.) In some implementations, temple end piece 204 may carry auxiliary display components, such as an antenna (not shown). The exact nature of the display components that temple arm 202 and/or temple end piece 204 may carry are not relevant to the articulated structure of temple 200. That is, articulated temple 200 may be used with a non-display eyewear, in which case neither of the temple arm 202 and temple end piece 204 may carry display components.

Referring to FIG. 2B, hinge 300 between temple arm 202 and temple end piece 204 may have a first hinge leaf 302 and a second hinge leaf 304. In one implementation, first hinge leaf 302 is disposed in a pocket 209 formed inside cavity 203 and located proximate rear end 210 of temple arm 202. First hinge leaf 302 is secured to a wall 211 of pocket 209, for example, by at least one fastener 217, such as a screw or the like. The position and orientation of wall 211 are such that the fastener 217 is hidden within temple arm 202. This avoids visible hole and fastener on the outside surface of the temple arm 202 that may not be aesthetically pleasing. Second hinge leaf 304 is partially embedded in temple end piece 204 such that a portion of second hinge leaf 304 protrudes from the front end 212 of temple end piece 204. First hinge leaf 302 is coupled to second hinge leaf 304 by a pivot joint 306, which defines a pivot axis 308. In the implementation shown in FIG. 2B, the protruding part of second hinge leaf 304 is received into pocket 209 through rear end 210 of temple arm 202, pivot joint 306 formed between first hinge leaf 302 and second hinge leaf 304 is located inside pocket 209. In other implementations, pivot joint 306 may be located inside temple end piece 204. This may include, for example, allowing part of first hinge leaf 302 to protrude from the rear end 210 of the temple arm 202 and for the second hinge leaf 304 to be fully embedded inside the temple end piece 204. In addition, a pocket may be formed near the front end 212 of the temple end piece 204 to receive the protruding part of the first hinge leaf 202 and allow a pivot joint to be formed between the protruding part of the first hinge leaf and the second hinge leaf in the pocket.

By hinge 300, temple end piece 204 may be pivoted about pivot axis 308 to any one of a folded configuration (in FIG. 2C), an extended configuration (in FIG. 2D), and an over-flexed configuration (in FIG. 2E). As shown in FIG. 2C, temple end piece 204 may pivot inwardly, from the extended configuration to the folded configuration, through an angle 205. Hinge 300 (in FIG. 2B), or a side edge of temple arm 202 that temple end piece 204 encounters during inward pivoting, may determine the maximum value of angle 205. In one example, which is not to be considered as limiting, the maximum value of angle 205 may be in a range from 80° to 100°. As shown in FIG. 2E, temple end piece 204 pivots outwardly, from the extended configuration to the over-flexed configuration, through an angle 207. Hinge 300 (in FIG. 2B), or a side edge of temple arm 202 that temple end piece 204 encounters during outward pivoting, may determine the maximum value of angle 207. In one example, which is not to be considered as limiting, the maximum value of angle 207 (in FIG. 2E) may be in a range from 5° to 20°. It should be understood that there are intermediate articulated positions of temple 200 between the extended configuration and folded configuration and between the extended configuration and the over-flexed configuration. “Folded configuration” is generally used to mean a configuration in which the temple end piece 204 is pivoted in an inward direction relative to temple arm 202 so as to shorten the length of temple 200. “Over-flexed configuration” is generally used to mean a configuration in which the temple end piece 204 is pivoted outwardly by a lateral force applied to the temple end piece 204. The temple end piece 204 is held in the over-flexed configuration by the lateral force. The lateral force may be applied to temple end piece 204 as the eyewear is placed on the head of the user or when the eyewear is worn on the head of the user. That is, as the eyewear is placed onto the head of the user, the shape of the head may force the temple end piece 204 out laterally. The temple end piece 204 may move back to the extended configuration once the eyewear is in place, or the eyewear may remain in an over-flexed configuration during wear. “Extended configuration” is a configuration in which the temple end piece 204 is aligned with the temple arm 202 such that front end 212 of temple end piece 204 is in direct opposing relation to rear end 210 of temple arm 202, or where the temple end piece 204 is not pivoted relative to temple arm 202, as shown in FIG. 2D. The terms “inward” and “outward” are relative to eyewear—“inward” would be towards the center of the eyewear, while “outward” would be away from the center of the eyewear.

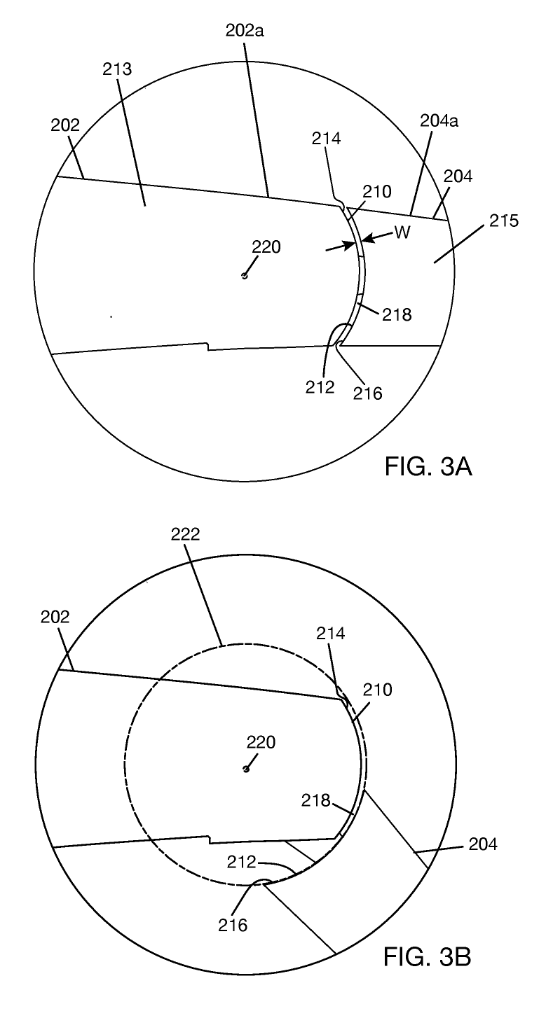

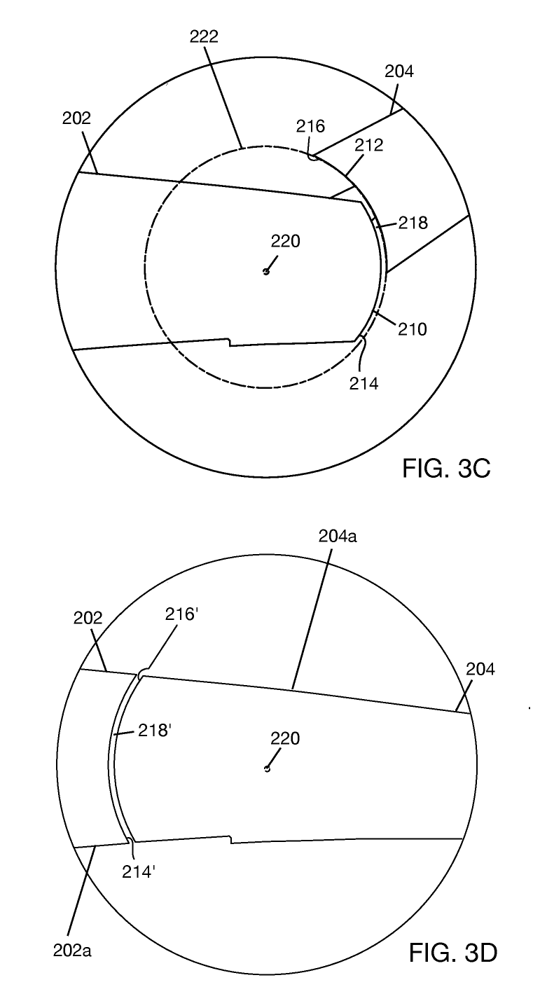

Returning to FIG. 2A, temple arm 202 has a top surface 213, and temple end piece 215 has a top surface 215. The top surfaces 213, 215 are the surfaces of temple arm 202 and temple end piece 204, respectively, that face up when an eyewear incorporating temple 200 is worn on the head of a user. As shown more clearly in FIG. 3A, top surface 213 terminates in a curved edge 214 at rear end 210 of temple arm 202, and top surface 215 terminates in a curved edge 216 at front end 212 of temple end piece 204. For convenience, curved edges 214, 216 may be referred to as top curved edges 214, 216, respectively. At the extended configuration of temple 200 (in FIGS. 2A and 3A), top curved edges 214, 216 are in direct opposing relation. In one implementation, a gap 218 is formed between top curved edges 214, 216. In the extended configuration, gap 218 extends across the lengths of the top curved edges 214, 216, as shown in FIG. 3A. Top curved edges 214, 216 are concentric about a pivot point 220 on pivot axis 308 (in FIG. 2B) of hinge 300 (in FIG. 2B). The concentricity of top curved edges 214, 216 about pivot point 220 allows gap 218 to be maintained between top curved edges 214, 216 as temple end piece 204 pivots relative to temple arm 202 through an allowed range of pivot angles. FIGS. 3B and 3C show temple end piece 204 at two different pivot angles relative to temple arm 202. The path of the temple end piece 204 as it pivots relative to temple arm 202 is that of a circle 222 that is centered at the pivot point 220.

In one example, such as shown in FIG. 3A, top curved edges 214, 216 have a matching circular (or constant radius arc) profile, and the width W of gap 218 is uniform along the lengths of top curved edges 214, 216. In another example (not shown), top curved edges 214, 216 may have curved profiles that are different such that the width of gap 218 is not uniform across the lengths of the top curved edges 214, 216. However, even for the example where the curved profiles may be different, the top curved edges should be concentric about pivot point 220. In general, gap 218 together with the concentricity of the top curved edges 214, 216 about the pivot point 220 allows the temple end piece 204 to pivot relative to the temple arm 202 about the pivot axis 308 (in FIG. 2B) without top curved edges 214, 216 ever coming into contact. In the over-flexed configuration, there is the possibility of hair or skin entering gap 218. By ensuring that the top curved edges 214, 216 never come into contact to close gap 218, the likelihood of hair or skin being pinched in between temple arm 202 and temple end piece 204 when temple 200 reverts to the extended configuration is eliminated or greatly diminished. In general, width W of gap 218 need only be large enough to allow clear separation of top curved edges 214, 216. In one example, which is not to be considered as limiting, width W of gap 218 may be in a range from 0.1 mm to 0.5 mm.

In another implementation, there may be no gap between top curved edges 214, 216 such that top curved edges 214, 216 are in sliding contact as temple end piece 204 pivots relative to temple arm 202. However, even in the example where there is no gap between the top curved edges 214, 216, the top curved edges 214, 216 are concentric about the pivot point 220 so that the top curved edge 216 does not intersect the top curved edge 214 as temple end piece 214 pivots relative to temple arm 202. The no-gap implementation may give the articulated arm a seamless appearance in the extended configuration.

In the implementation shown in FIG. 3A, pivot point 220 is located in a rear end portion 202a of temple arm 202 (this corresponds to pivot joint 306 in FIG. 2B being located within rear end portion 202a of temple 202), and top curved edges 214, 216 are located to the rear of pivot point 220. FIG. 3D illustrates another implementation where pivot point 220 is located in front end portion 204a of temple end piece 204 and top curved edges 214′, 216′ are located forward of the pivot point 220 (this corresponds to the alternate implementation previously described where pivot joint 306 in FIG. 2B may be located within temple end piece 204). Top curved edges 214′, 216′ are separated by gap 218′ and have similar characteristics to top curved edges 214, 216 (in FIG. 3A) in terms of concentricity about the pivot point and separation by a gap. Top curved edge 216′ will also follow a circular path as it moves relative to top curved edge 214′, or as temple end piece 204 pivots relative to temple arm 202 about pivot point 220. Also, as in the alternate example given above, it is possible to eliminate the gap 218′ between top curved edges 214′, 216′ such that there is sliding contact between top curved edges 214′, 216′ as the temple end piece 204 pivots relative to the temple arm 202.

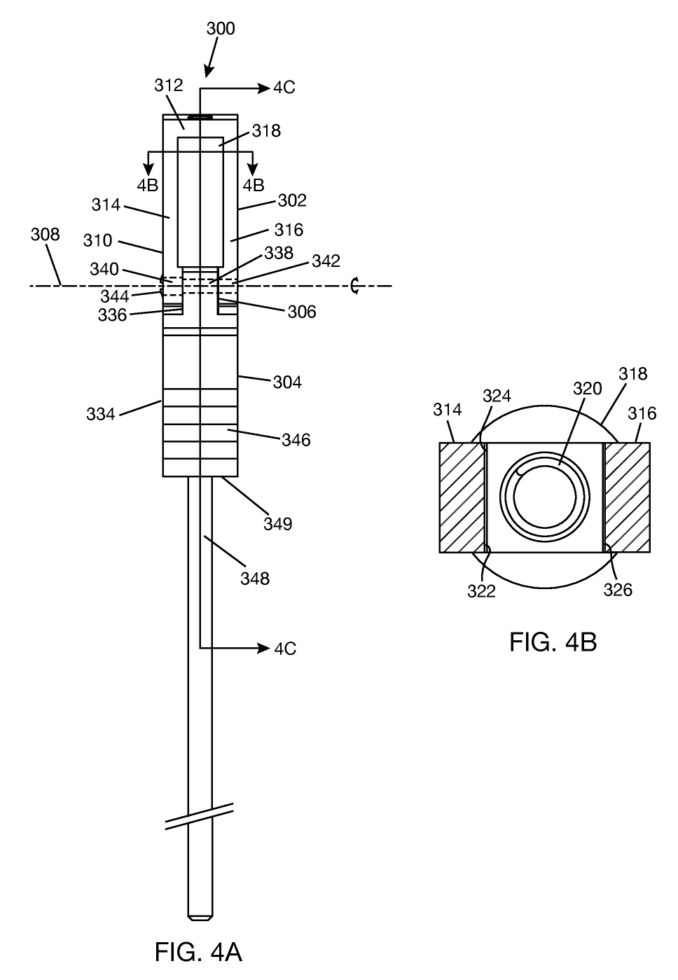

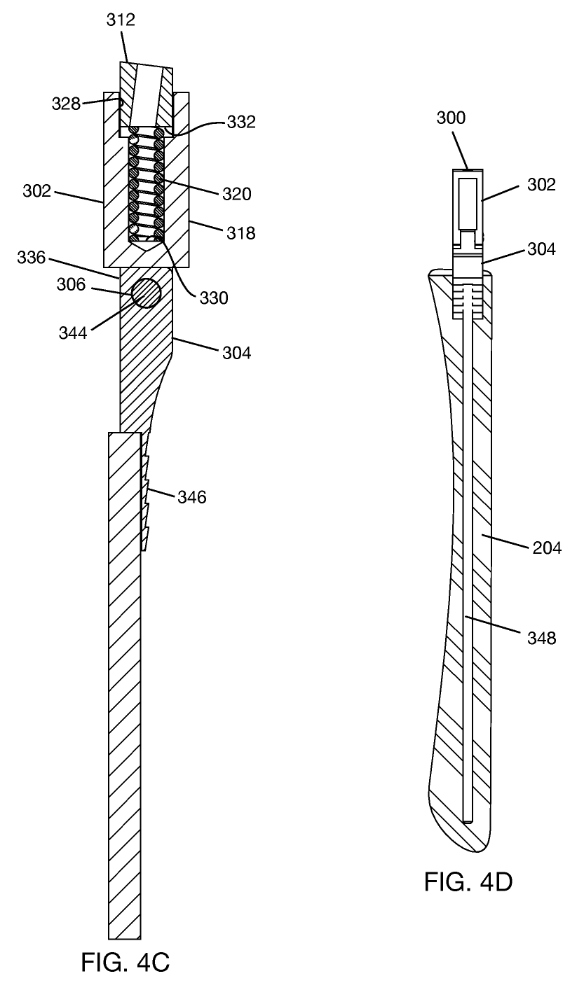

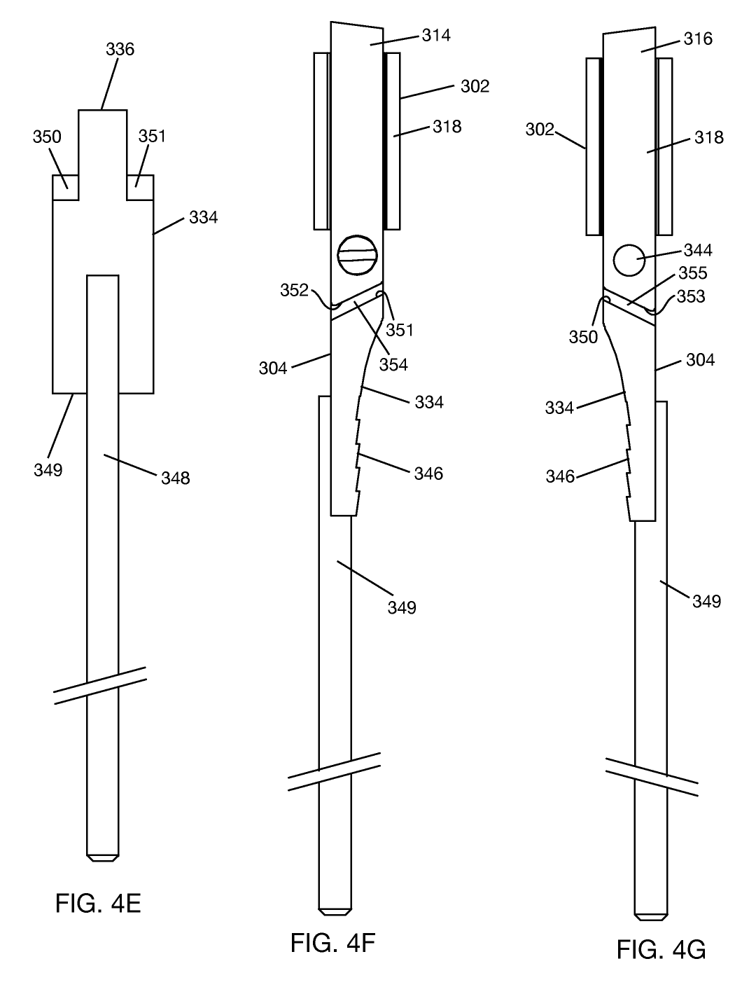

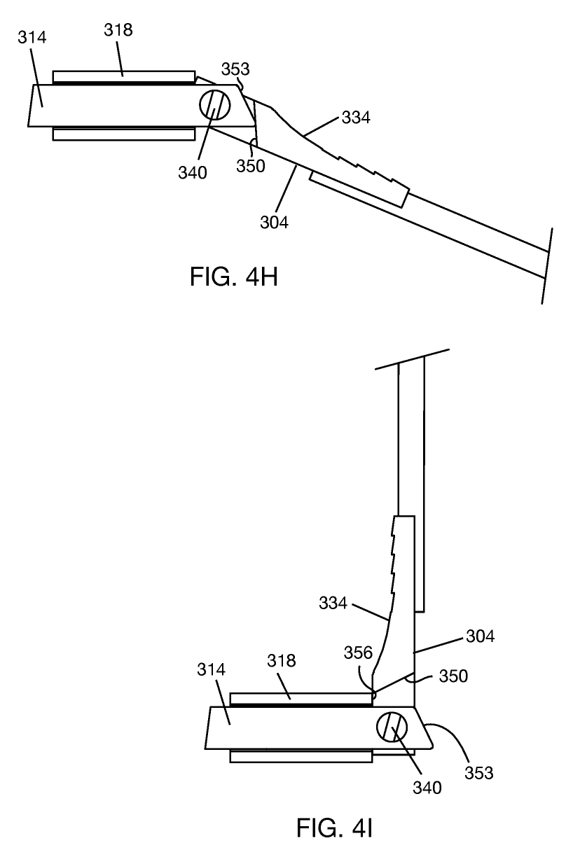

FIG. 4A shows hinge 300 according to one example. Hinge 300 includes first hinge leaf 302 that is coupled to second hinge leaf 304 by pivot joint 306 having pivot axis 308 (also, in FIG. 2B). In one example, first hinge leaf 302 includes a U-shaped frame 310 having an end bar 312 and side bars 314, 316 depending from the end bar 312. First hinge leaf 302 includes a spring housing 318 containing a spring 320 (in FIGS. 4B and 4C). Spring housing 318 is received in an opening 322 (in FIG. 4B) between side bars 314, 316. Longitudinal slots 324, 326 (in FIG. 4B) formed on opposite sides of spring housing 318 partially receive side bars 314, 316, allowing spring housing 318 to slide longitudinally relative to side bars 314, 316, where spring 320 (in FIGS. 4B and 4C) responds to relative sliding of spring housing 318. An upper end of spring housing 318 includes a slot 328 (in FIG. 4C) in which end bar 312 is partially received. As shown in FIG. 4C, spring 320 extends from the inner bottom surface 330 of spring housing 318 to the bottom surface 332 of end bar 312. This means that as spring housing 318 slides relative to side bars 314, 316 (in FIG. 4A), spring 320 is extended or compressed between spring housing 318 and frame end bar 312.

Returning to FIG. 4A, second hinge leaf 304 includes a hinge plate 334. A knuckle 336 is formed at an upper end of hinge plate 334. Knuckle 336 has a hole 338 through which a pivot pin 344 (only the head of the pivot pin is visible in FIG. 4A; see, also FIG. 4C) passes. Side bars 314, 316 also have holes 340, 342, respectively, through which pivot pin 344 passes. To form pivot joint 306, knuckle 336 is inserted in the opening between side bars 314, 316 such that holes 338, 340, 342 are aligned. Pivot pin 344 is inserted in the aligned holes 338, 340, 342 and retained in place using any suitable method that allows knuckle 336 to pivot relative to side bars 314, 316.

When pivot joint 306 is formed, spring housing 318, which contains spring 320 (in FIGS. 4B and 4C), is between frame end bar 312 and pivot joint 306, or between frame end bar 312 and knuckle 336. During pivoting of second hinge leaf 304 relative to first hinge leaf 302 about pivot axis 308, spring housing 318 engages knuckle 336 (see FIG. 4C) such that pivoting motion of knuckle 336 may be translated to sliding motion of spring housing 318. Spring 320 between spring housing 318 and frame end bar 312 exerts a spring force on pivot joint 306 in response to pivoting motion of knuckle 336. Thus, in one implementation, pivot joint 306 may be described as being loaded by a spring. The spring force can act as a restoring force to return the temple end piece from the over-flexed configuration (in FIG. 2E) to the extended configuration (in FIG. 2D) or as a force to retain the temple end piece in the folded configuration (in FIG. 2C).

Returning to FIG. 4A, in one example, second hinge leaf 304 includes one or more structures to facilitate embedding of second hinge leaf 304 in temple end piece 204 (in FIG. 2B) by molding. In one example, the structures may include a serrated surface 346 (also, in FIG. 4C) on a lower portion of hinge plate 334 to be embedded in the temple end piece. Serrated surface 346 may serve to lock hinge plate 334 to the temple end piece after molding. In one example, the structures may include a wire 348, such as a core wire, attached to the hinge plate 334 so as to form a tail of a select length at an end 349 of hinge plate 334. Wire 348 may help retain the shape of the temple end piece after molding. The portion of second hinge leaf 304 including serrated surface 346 and/or wire 348 may be regarded as a mold insert over which material may be molded to form the temple end piece. In general, wire 348 may be made of metal, or alloy, or other suitable mold insert material. Wire 348 should have sufficient stiffness to retain the shape of the temple end piece after molding. As shown in FIG. 4D, the length of wire 348 may be selected such that wire 348 extends substantially along the length of temple end piece 204. The diameter of wire 348 will be dictated by the thickness or width of temple end piece 204 and by a stiffness to retain the shape of the temple end piece after molding.

Referring to FIGS. 4E, 4F, and 4G, the upper end of hinge plate 334 includes a pair of tapered surfaces 350, 351 flanking opposite sides of knuckle 336. Complementary tapered surfaces 352, 353 are formed at the bottom of side bars 314, 316, respectively. When second hinge leaf 304 is axially aligned with first hinge leaf 302, i.e., when second hinge leaf 304 is not pivoted relative to first hinge leaf 302, tapered surfaces 352, 351 form parallel surfaces that are separated by a gap 354. Similarly, tapered surfaces 352, 350 form parallel surfaces that are separated by a gap 355. The gaps 354, 355 allow second hinge leaf 304 to pivot relative to first hinge leaf 302 through a range of pivoting angles. Second hinge leaf 304 may pivot in one direction until the tapered surfaces 351, 350 contact the respective tapered surfaces 352, 353 and the gaps 354, 355, respectively, are closed. This is illustrated for tapered surfaces 350, 353 in FIG. 4H. The second hinge leaf 304 may pivot in another direction until the hinge plate 334 contacts the bottom 356 of spring housing 318, as shown in FIG. 4I. Thus, in one direction, the tapered surfaces 352, 353 (in FIGS. 4F and 4G) act as stop surfaces to limit pivoting of the second hinge leaf 304 relative to the first hinge leaf 302. In another direction, bottom 356 (in FIG. 4I) of spring housing 318 acts as a stop surface to limiting pivoting of the second hinge leaf 304 relative to the first hinge leaf 302. When hinge 300 is integrated in the articulated temple 200 (in FIGS. 2A and 2B), side edges on the temple arm 202 (in FIG. 2A) may further limit the range of pivot angles, e.g., if a narrower range of pivot angles than provided by the hinge is desired.

The above description of illustrated embodiments, including what is described in the Abstract of the disclosure, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art.

1. An articulated temple, comprising:
a temple arm having a rear end and a top surface, the top surface of the temple arm terminating in a first curved edge at the rear end;
a temple end piece having a front end to be positioned in opposing relation to the rear end of the temple arm such that the temple arm and the temple end piece together form a temple having a select shape and length, the temple end piece having a top surface, the top surface of the temple end piece terminating in a second curved edge at the front end; and
a hinge having a first hinge leaf coupled to the temple arm and a second hinge leaf coupled to the temple end piece, the hinge having a pivot joint formed between the first hinge leaf and the second hinge leaf proximate the rear end of the temple arm and the front end of the temple end piece, the pivot joint defining a pivot axis;
wherein the first curved edge and the second curved edge are concentric about the pivot axis to enable the second curved edge to move relative to the first curved edge along a portion of a circular path when the temple end piece is pivoted relative to the temple arm about the pivot axis.

2. The articulated temple of claim 1, wherein each of the first curved edge and the second curved edge has a constant radius arc profile.

3. The articulated temple of claim 1, wherein the first curved edge and the second curved edge are spaced apart by a gap.

4. The articulated temple of claim 1, which has a folded configuration wherein the temple end piece is pivoted relative to the temple arm in a first direction by a first angle and an over-flexed configuration wherein the temple end piece is pivoted relative to the temple arm in a second direction while the temple end piece is subjected to an applied lateral force, wherein a maximum value of the first angle is in a range from 80° to 100°, and wherein a maximum value of the second angle is in a range from 5° to 20°.

5. The articulated temple of claim 1, further comprising a spring that loads the pivot joint.

6. The articulated temple of claim 5, wherein the first hinge leaf comprises a frame and a spring housing slidably engaging the frame, wherein the spring is arranged between the spring housing and the frame to respond to relative sliding between the spring housing and the frame, and wherein the second hinge leaf contacts the spring housing to transfer pivoting motion of the second hinge leaf relative to the first hinge leaf to sliding motion of the spring housing relative to the frame.

7. The articulated temple of claim 1, wherein the pivot joint is located in an interior of one of the temple arm and temple end piece.

8. The articulated temple of claim 7, wherein the first hinge leaf is disposed in a pocket in the interior of the temple arm and coupled to a wall of the pocket by at least one fastener, and wherein the wall is positioned and oriented to hide the fastener within the temple arm.

9. The articulated temple of claim 1, wherein the second hinge leaf comprises a hinge plate having a knuckle formed at an end thereof, and wherein the pivot joint is formed between the knuckle and the first hinge leaf.

10. The articulated temple of claim 9, wherein the temple end piece is a molded body, wherein a portion of the hinge plate includes a serrated surface, and wherein the portion of the hinge plate including the serrated surface is embedded in the temple end piece to lock the hinge plate to the temple end piece.

11. The articulated temple of claim 9, wherein the temple end piece is a molded body, wherein the second hinge leaf further comprises a wire attached to the hinge plate, and wherein the wire is embedded in the temple end piece to retain a shape of the temple end piece.

12. The articulated temple of claim 1, wherein the first hinge leaf includes at least a first stop surface that limits pivoting of the second hinge relative to the first hinge leaf in a first direction and at least a second stop surface that limits pivoting of the second hinge relative to the first hinge leaf in a second direction.

13. An eyewear, comprising:
a frame front carrying at least one lens; and
at least one articulated temple coupled to a side of the frame, the at least one articulated temple comprising:
a temple arm having a front end coupled to the side of the frame front, a rear end, and a top surface, the top surface of the temple arm terminating in a first curved edge at the rear end;
a temple end piece having a front end to be positioned in opposing relation to the rear end of the temple arm such that the temple arm and the temple end piece together form a temple having a select shape and length, the temple end piece having a top surface, the top surface of the temple end piece terminating in a second curved edge; and
a hinge having a first hinge leaf coupled to the temple arm near the rear end of the temple arm and a second hinge leaf coupled to the temple end near the front end of the temple end piece, the hinge having a pivot joint formed between the first hinge leaf and the second hinge leaf, the pivot joint defining a pivot axis;
wherein the first curved edge and the second curved edge are concentric about the pivot axis to enable the second curved edge to move relative to the first curved edge along a circular path when the temple end piece is pivoted relative to the temple arm about the pivot axis.

14. The eyewear of claim 13, wherein the at least one articulated temple carries at least one display component.

15. The eyewear of claim 13, wherein each of the first curved edge and the second curved edge has a constant radius arc profile.

16. The eyewear of claim 13, wherein the first curved edge and the second curved edge are spaced apart by a gap.

17. The eyewear of claim 13, which has a folded configuration wherein the temple end piece is pivoted relative to the temple arm in a first direction by a first angle and an over-flexed configuration wherein the temple end piece is pivoted relative to the temple arm in a second direction while the temple end piece is subjected to an applied lateral force, wherein a maximum value of the first angle is in a range from 80° to 100°, and wherein a maximum value of the second angle is in a range from 5° to 20°.

18. The eyewear of claim 13, further comprising a spring that loads the pivot joint.

19. The eyewear of claim 18, wherein the pivot joint is located in an interior of one of the temple arm and temple end piece.

20. The eyewear of claim 13, wherein the first hinge leaf is disposed in a pocket in the interior of the temple arm and coupled to a wall of the pocket by at least one fastener, and wherein the wall is positioned and oriented to hide the fastener within the temple arm.
